(19) United States
(12) Patent Application Publication
(10) Pub. No.: US 2011/0145368 A1
(43) Pub. Date: Jun. 16, 2011

(54) ASSESSMENT FEEDBACK SYSTEM

(76) Inventor: Mamoru Ito, Tokyo (JP)

(21) Appl. No.: 12/737,026

(22) PCT Filed: May 30, 2008
(86) PCT No.: PCT/JP2008/060003

§ 371 Date: Feb. 22, 2011

(51) Int. Cl. G06F 15/16

(52) U.S. Cl. 709/219

(57) ABSTRACT

The assessment of an assessed person by an assessor is fed back to the assessed person together with his/her self-assessment to provide the assessed person with an opportunity to consider the assessments. An assessment feedback system of the present invention is such that the assessed person and the assessor perform assessments along a main assessment document, in which assessment items (questions) relating to the attitudes and behavior of the assessed person are classified by category. The main assessment results (360 fb: grasp of current situation) are then fed back to the assessed person to select one assessment item for each category, based on the main assessment results. This leads to create a subsidiary assessment document for performing an intermediate assessment (360 fb: intermediate measurement) along the subsidiary assessment document. Finally, a final assessment is performed along the main assessment document (360 fb: final measurement).

This application claims the benefit of and is a national stage application under 35 U.S.C. §371 of International Application Serial No. PCT/JP2008/060003 filed on May 30, 2008, which is hereby expressly incorporated by reference in its entirety for all purposes.

### TECHNICAL FIELD

The present invention relates to an assessment feedback system in which the assessment of an assessed person by an assessor is obtained together with self-assessment by the assessed person and fed back to the assessed person to provide the assessed person with an opportunity to consider the assessment.

### BACKGROUND ART

It is believed that communication serves as a fundamental basis of building personal relationships and success through leadership. Smooth communication improves the performance of people around. Since cooperative leadership and relationship-building are required in on-site environments, it is indispensable for future business success that leaders should learn cooperative coaching skills.

Under such circumstances, it is important to assess how you are seen from others, a gap between self-image and being seen from others, and how your leadership affects those around in order to give you greater insight into the assessment, promoting self-growth and development.

### DISCLOSURE OF THE INVENTION

### Problems to be Solved by the Invention

Although there are systems for feeding back self-assessment by an assessed person and the assessment of the assessed person by an assessor to the assessed person, there is no system for providing greater insight based on the assessment results fed back. There is also no system for promoting self-growth and development based on the assessment results.

The present invention has been made in view of such points, and an object thereof is to feed back the assessment of an assessed person by an assessor to the assessed person together with self-assessment by the assessed person in order to provide the assessed person with an opportunity to consider the assessment.

### Means for Solving the Problems

In order to solve the above problems, an assessment feedback system of the present invention features that an assessed person and an assessor perform assessments along a main assessment document, in which assessment items (questions) relating to the attitudes and behavior of the assessed person are classified by category, and the main assessment results are fed back to the assessed person. On that basis, one assessment item is selected for each of plural categories based on the main assessment results fed back to create a subsidiary assessment document so as to perform an assessment along the subsidiary assessment document. Finally, the assessment is performed along the main assessment document.

To be more specific, the present invention provides the following:

(1) An assessment feedback system including output means for outputting data or instructions to external terminals, input means for receiving input of data or instructions from the external terminals, aggregation means for performing processing for aggregating data received from the external terminals, request means for requesting data or instructions from the external terminals, and data generation means for generating various data, the system comprising the steps of: outputting, by means of the output means, main assessment questionnaire data having a plurality of assessment items provided for each of a plurality of categories and assessment factors provided for each of the plurality of assessment items separately to a student terminal and a terminal other than that of the student both of which are permitted; receiving, by means of the input means, one assessment factor selected for each of the plurality of assessment items from each of the external terminals as main assessment data; aggregating, by means of the aggregation means, main assessment data received from the student terminal and main assessment data received from the terminal other than that of the student for each of the plurality of assessment items; generating, by means of the data generation means, the aggregated data as main assessment result data; outputting, by means of the output means, the generated main assessment result data to the student terminal; requesting, by means of the request means, the student terminal to select one assessment item for each of the plurality of categories from among the plurality of assessment items provided for each of the plurality of categories; receiving, by means of the input means, one piece of assessment item data selected for each of the plurality of categories from the student terminal that has received the request; and generating, by means of the data generation means, subsidiary assessment questionnaire data having the one assessment item selected for each of the plurality of categories and the assessment factors provided for each assessment item.

(2) The assessment feedback system further comprising the steps of: requesting, by means of the request means, the student terminal and the terminal other than that of the student, both of which are permitted, to select one assessment factor for each of the plurality of assessment items by referring to the subsidiary assessment questionnaire data; receiving, by means of the input means, one assessment factor selected for each of the plurality of assessment items from each of the external terminals as subsidiary assessment data; aggregating, by means of the aggregation means, the subsidiary assessment data received from the student terminal and the subsidiary assessment data received from the terminal other than that of the student for each of the plurality of assessment items; generating, by means of the data generation means, the aggregated data as subsidiary assessment result data; and outputting, by means of the output means, the generated subsidiary assessment result data to the student terminal.

(3) The assessment feedback system further comprising the steps of; aggregating, by means of the aggregation means, the main assessment data and the subsidiary assessment data for each of the plurality of assessment items; generating, by means of the data generation means, the aggregated data as main-subsidiary assessment result data; and outputting, by means of the output means, the generated main-subsidiary assessment result data.

### Effects of the Invention

According to the present invention, the main assessment data obtained as a result of the assessments of the student based on the main assessment questionnaire data are sent to a server from the student and a person(s) other than the student, and main assessment result data is generated from both pieces of main assessment data and sent to the student terminal. This enables the student to figure out how the other person(s) assesses the student and how much a gap there is between the assessment and the self-assessment.

Then, subsidiary assessment questionnaire data obtained by narrowing down the main assessment questionnaire data in terms of what the student should be careful about from this time and the like are generated. During predetermined training, assessments are performed based on the subsidiary assessment questionnaire data, and the assessment results are sent as subsidiary assessment data to the server from the student and the person(s) other than the student. Then, from both pieces of subsidiary assessment data, subsidiary assessment result data are generated and sent to the student. This enables the student to compare the subsidiary assessment result data with the main assessment result data to figure out the degree of improvement of the student's skills in addition to figuring out what the other person(s) assesses the student and how much a gap there is between the assessment and the self-assessment. A main-subsidiary assessment result data in which the main assessment result data and the subsidiary assessment result data are put together can also be provided to improve the visualization of the differences therebetween.

### BEST MODE FOR CARRYING OUT THE INVENTION

An information analysis system according to a preferred embodiment of the present invention will now be described with reference to the accompanying drawings.

FIG. 1 shows a business scheme using an assessment feedback system according to the embodiment of the present invention.

In other words, this is a short-term, intensive course with 12 sessions of three to four months offered to students who take this course as assessed persons in order to acquire coaching skills that can be used in business scenes, which helps the students think and acquire communication skills that can promote the voluntary behavior of the students, contributing to improvement in leadership, management and nurturing of subordinates.

This business scheme aims to help acquire coaching skills, capable of intentionally creating a coaching conversation, and catch on the continuous development of the coaching skills, thereby nurturing subordinates to improve business results and building a corporate culture.

This business scheme features training designed to ensure the “ability to put in practice” rather than “knowledge,” where the assessed persons receive feedback repeatedly as a result of conscious actions to ensure that the skills catch on. Using a telephone conference system, the students can participate in from anywhere and the voice calls that depend only on the sense of hearing enable the students to polish the “ability to listen with purpose.”

Specifically, a student as an assessed person attends an orientation with the aim of touching on the concept of coaching skills that can be used as a management style. After the orientation, the student assesses himself or herself along a main assessment document (e.g., a 30-item questionnaire). On the other hand, further assessments of the student are also obtained from persons concerned as assessors other than the student, such as a manager, a peer and a subordinate, along the same main assessment document as for the student. These assessments are performed using external terminals. A flow of subsequent processes until subsidiary assessment result data is obtained will be described later. Thus, the aggregation results with the assessments by the assessors other than the student added in addition to the self-assessment by the student are fed back to the student as main assessment results. Since it is shown, from an objective standpoint, how the student is seen from others, a gap between self-image and being seen from others, and how his or her leadership affects those around, the student can grasp his or her current situation.

Based on the main assessment results obtained from the objective standpoint, the student selects some assessment items (e.g., five questions) on which attention should focus to promote self-growth and development so as to identify the assessment items of the subsidiary assessment document. On that basis, 12 training sessions are started.

The training is such that one session is a small-group session (e.g., four persons) lasting about 55 minutes with one coach and several students using a speech-based telephone conference system. At the telephone conference, the students get lectured on a topic, and besides, the session may include discussions, role-play exercise, feedback, sharing of successful experiences, study of failed cases, case study, etc. In so doing, the coach gives guidance and advice.

After completion of the 12 training sessions, each student assesses himself or herself again along the main assessment document (e.g., the 30-item questionnaire). On the other hand, further assessments of the student are also obtained from persons concerned as assessors other than the student, such as a manager, a peer and a subordinate, along the same main assessment document as for the student. The main assessment results obtained first are compared with the main assessment results obtained at the end so that the student can figure out how much his or her coaching skills are improved. In other words, a series of training sessions can be provided through which the student is given greater insight based on the main assessment results obtained first, self-growth and development are promoted based on this main assessment results, and the main assessment results are also obtained again at the end of the training.

Further, a few intermediate measurements are made during the 12 training sessions (e.g., in the fifth and ninth sessions). This is to obtain the self-assessment from the student and assessments of the student from the persons concerned as assessors other than the student, such as a manager, a peer and a subordinate, based on the five assessment items of the subsidiary assessment document to obtain subsidiary assessment results based on the five assessment items. This can give opportunities to consider the assessments during the training.

FIG. 2 is a diagram showing a configuration of the assessment feedback system according to the embodiment of the present invention.

A server 21 in an assessment feedback system 10 is connected to a network 51 such as the Internet, and connected to external terminals 41A, 41B and the like through the network 51. The external terminals include a student terminal operated by an assessed person and a terminal operated by an assessor other than the student and concerned with the assessed person. Only the external terminals (student terminals and terminals of those other than the students) permitted to access as a result of authentication with ID and/or PW can log in to a home page and subsequent pages offered by the server 21. The external terminals 41A, 41B and the like may be connected to telephone sets 141A, 141B to enable voice communication. In this case, two or more telephone sets 141A, 141B and the like can communicate with each other through a network 51.

FIG. 3 is a block diagram of the assessment feedback system 10 according to the embodiment of the present invention.

The assessment feedback system 10 has input means 1, output means 2, I/O control means 3, storage means 4, aggregation means 5, data generation/processing means 6 and request means 7. Each means is connected by a bus to carry out each function, respectively.

The input means 1 receives input of various data and instructions from external terminals, reading main assessment data and subsidiary assessment data sent through the Internet or the like. The output means 2 outputs various data and instructions to the external terminals, sending main assessment questionnaire data, subsidiary assessment questionnaire data, main assessment result data, subsidiary assessment result data and the like through the Internet or the like.

The I/O control means 3 functions as an interface for interpreting an instruction or the content input via the input means 1 to supply it to the data generation/processing means 6, interpreting various instructions from the data generation/processing means 6 to control the output of the output means 2, and interpreting various instructions to control the output of the request means 7. The I/O control means 3 also functions as an interface for writing, into the storage means 4, various data input to the input means 1 and reading various data to be output to the output means 2.

The storage means 4 has a work area 4a provided in a main memory (RAM), a data storage area 4b provided in a secondary storage device such as a disk unit (floppy disk, hard disk, magneto-optical disk or the like) or the like, and a screen definition storage area 4c. The work area 4a is an area allocated upon system startup to store various input data temporarily. The data storage area 4b is an area for storing data semi-permanently by controlling writing in response to a request for saving data temporarily stored in the work area 4a. The screen definition storage area 4c is an area in which screen definition information on various screens the system should display in a display section is prestored.

The aggregation means 5 performs processing for aggregating data received from the external terminals, where main assessment data and subsidiary assessment data are aggregated for each of plural assessment items.

The data generation/processing means 6 generates data in an appropriate format while temporarily storing the data aggregated by the aggregation means 5 in the work area 4a, i.e., it generates main assessment result data, subsidiary assessment result data, main-subsidiary assessment result data and the like.

The request means 7 is to urge the student terminal and the terminals other than that of the student to perform assessments, i.e., urge to access a predetermined site by e-mails and perform assessments. Alternatively, input operations are performed in response to main assessment questionnaire mail data and subsidiary assessment questionnaire mail data preferably as HTML mails to enter assessments, and return mail operations are performed to send the server the main assessment data and the subsidiary assessment data. As for an external terminal that does not support HTML mail, since main assessment questionnaire data and subsidiary assessment questionnaire data are sent in text format, the mails are displayed by a browser on the terminal, and after entering answers, the answers are returned to the server.

Next, the details of the data storage area 4b will be described with reference to FIG. 4 to FIG. 10.

The data storage area 4b is partitioned into an assessment questionnaire database 4b₁ for storing the main assessment questionnaire data and the subsidiary assessment questionnaire data, an assessment database 4b₂ for storing the main assessment data and the subsidiary assessment data, a main-subsidiary assessment result database 4b₃ for storing the main assessment result data and the subsidiary assessment result data, and various databases 4b₄ for storing various other data.

As shown in FIG. 4, the main assessment questionnaire data stored in the assessment questionnaire database 4b₁ has plural assessment items (one to fifteen items) for each of plural categories (e.g., Listening, Building Trust, Acknowledging) and assessment factors (e.g., Very high, High, Moderate, Low, Very low) prepared for each of the plural assessment items. Specifically, the category of Listening has five assessment items, the category of Building Trust has five assessment items, and the category of Acknowledging has five assessment items. The assessment factors that affect the assessment of the assessed person are provided for each assessment item, and each assessor selects one assessment factor from these assessment factors in each of the assessment items.

The main assessment questionnaire data is created beforehand, prestored in the main assessment questionnaire database 4b₁, and automatically output to the external terminals, but an appropriate change can also be made to this data. In this case, the format data of the main assessment questionnaire data stored in the various databases 4b₄ are read first to set the types (choices) of assessment factors and coefficients (weighting coefficients) respectively added thereto (FIG. 5), then to set the categories and the number of assessment items (number of questions) for each category (FIG. 6), and then to set the assessment items (the content of questions) in association with each category (FIG. 7). The categories, the number of assessment items and the types of assessment factors, which construct the main assessment questionnaire data, can be set freely. Besides the assessments based on the assessment factors, any free response item (open question) capable of getting a free answer without regard to any assessment factor can also be provided as an assessment item.

As shown in FIG. 8, the subsidiary assessment questionnaire data stored in the assessment questionnaire database 4b₁ is such that one assessment item corresponds to one category, having the assessment factors for each assessment item. The subsidiary assessment questionnaire data are generated in response to input from the student terminal. Specifically, one assessment item selected on the student terminal for each of the plural categories in a checkbox format is set (FIG. 9), and the server receives one assessment item corresponding to one category and requests confirmation from the student terminal, thus generating the subsidiary assessment questionnaire data (FIG. 10).

FIG. 11 shows an example of the main assessment result data and the subsidiary assessment result data or the main-subsidiary assessment result data stored in the main-subsidiary assessment result database 4b₃. FIG. 11 shows the main assessment result data on a main assessment performed 2008/04/27, where the main assessment data received from the student terminal are indicated by the filled circle and the main assessment data received from the terminals other than that of the student are indicated by numeric values to distinguish therebetween, and listed for each of assessment factors (Very applicable, Relatively applicable, Not applicable, Don't know). The main assessment data are aggregated by assessment item and so constructed that the main assessment data can be displayed in the form of a list as main assessment result data. The subsidiary assessment result data are also constructed in the same manner. In regard to the main assessment result data and the subsidiary assessment result data, when the assessment data received from the terminals other than that of the student are indicated by numeric values, the numeric values can be displayed to distinguish among relations of the persons with the student, such as the manager, the peer and the subordinate. Thus, the assessment data are visually distinguished between the student and the persons other than the student, and this enables objective assessments of the student as seen from the persons other than the student.

FIG. 12 is a diagram showing a flow of data in the assessment feedback system 10 according to the embodiment of the present invention.

The server sends main assessment questionnaire data to the student terminal and the terminals other than that of the student (step S1). The data can be sent in such a manner that the student and the like access the server or the data are attached to e-mails. When the main assessment questionnaire data are received by the student terminal and the terminals other than that of the student, responses to the main assessment questionnaire are given, and the response results are sent to the server as the main assessment data (step S2). Since the student and the persons other than the student usually see and respond to the main assessment questionnaire at different times, respective main assessment data are sent separately. The sent main assessment data are grouped into that from the student and those from the persons concerned other than the student on a student-by-student basis, and stored in the assessment database 4b₂.

The server that has received the main assessment data from the student and the persons other than the student in the same group are aggregated. The aggregation results are generated as the main assessment result data, and stored in the main-subsidiary assessment result database 4b₃. Then, the generated main assessment result data are read from the main-subsidiary assessment result database 4b₃, and sent to the student terminal (step S3). Thus, the student can refer to the assessments by others in the group to which the student belongs to figure out a correlation with or a gap from the self-assessment. The main assessment result data can also be sent to the terminals other than that of the student.

The student terminal that has received the main assessment result data sets basic data for generating subsidiary assessment questionnaire data from the main assessment results. Specifically, the student selects one assessment item for one category in terms of what should be improved, what to focus on or the like while referring to the main assessment results, and sets the selected assessment items as targets for the next and subsequent assessments. The basic data set with student's operations on the student terminal to generate the subsidiary assessment questionnaire data are sent to the server (step S4), generated by the data generation/processing means 6 as the subsidiary assessment questionnaire data, and stored in the assessment questionnaire database 4b₁.

The student terminal and the terminals other than that of the student are notified of the subsidiary assessment questionnaire data by the request means 7. Specifically, since the subsidiary assessment questionnaire is conducted at the right time according to the progress of training for the student, the subsidiary assessment questionnaire data are sent to the student terminal and the terminals other than that of the student at the right time (step S5). The data can be sent in such a manner that the student and the like access the server or the data are attached to e-mails. When the subsidiary assessment questionnaire data are received by the student terminal and the terminals other than that of the student, responses to the subsidiary assessment questionnaire are given, and the response results are sent to the server as subsidiary assessment data (step S6). Since the student and the persons other than the student usually see and respond to the subsidiary assessment questionnaire at different times, respective subsidiary assessment data are sent separately. The sent subsidiary assessment data are grouped into that from the student and those from the persons concerned other than the student on a student-by-student basis, and stored in the assessment database 4b₂.

The server that has received the subsidiary assessment data from the student and the persons other than the student in the same group are aggregated. The aggregation results are generated as the subsidiary assessment result data, and stored in the main-subsidiary assessment result database 4b₃. Then, the generated subsidiary assessment result data are read from the main-subsidiary assessment result database 4b₃ and sent to the student terminal (step S7). Thus, the student can refer to the assessments by others in the group to which the student belongs to figure out a correlation with or a gap from the self-assessment. The subsidiary assessment result data can also be sent to the terminals other than that of the student.

Here, if the main assessment data and the subsidiary assessment data are all ready, they can be mixed as the main-subsidiary assessment result data and sent to the student terminal (step S7). In this case, since the student can refer to complete histories, the degree of improvement in the student's skills can be figured out at a glance.

Further, the assessment factors can be quantified and added for each assessment item as the main assessment result data and the subsidiary assessment result data or the main-subsidiary assessment result data, and calculated as scores.

### INDUSTRIAL APPLICABILITY

The assessment feedback system according to the present invention is useful in obtaining the assessment of an assessed person by an assessor together with self-assessment by the assessed person, and feeding back the content of these assessments to the assessed person to provide the assessed person with an opportunity to consider the assessments.

### BRIEF DESCRIPTION OF THE DRAWINGS

FIG. 1 shows a business scheme using an assessment feedback system according to a preferred embodiment of the present invention.

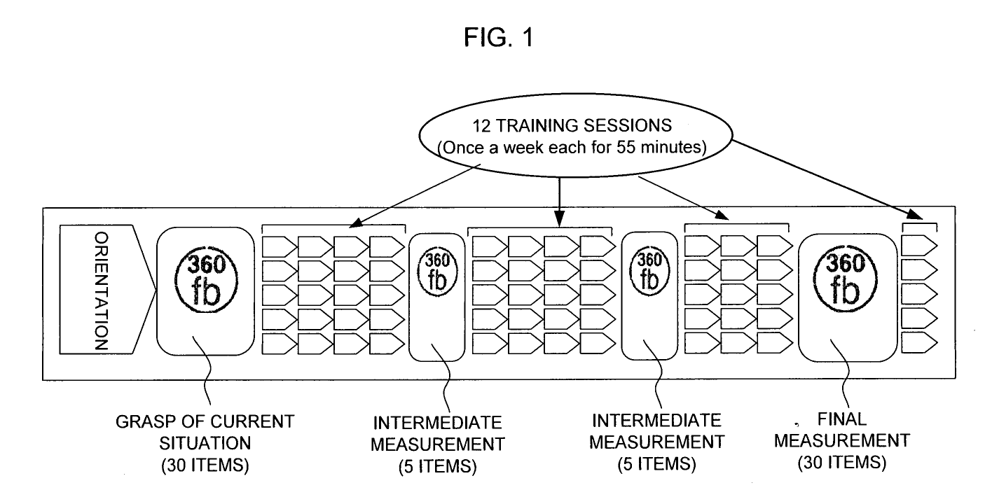

FIG. 2 is a diagram showing a configuration of the assessment feedback system according to the embodiment of the present invention.

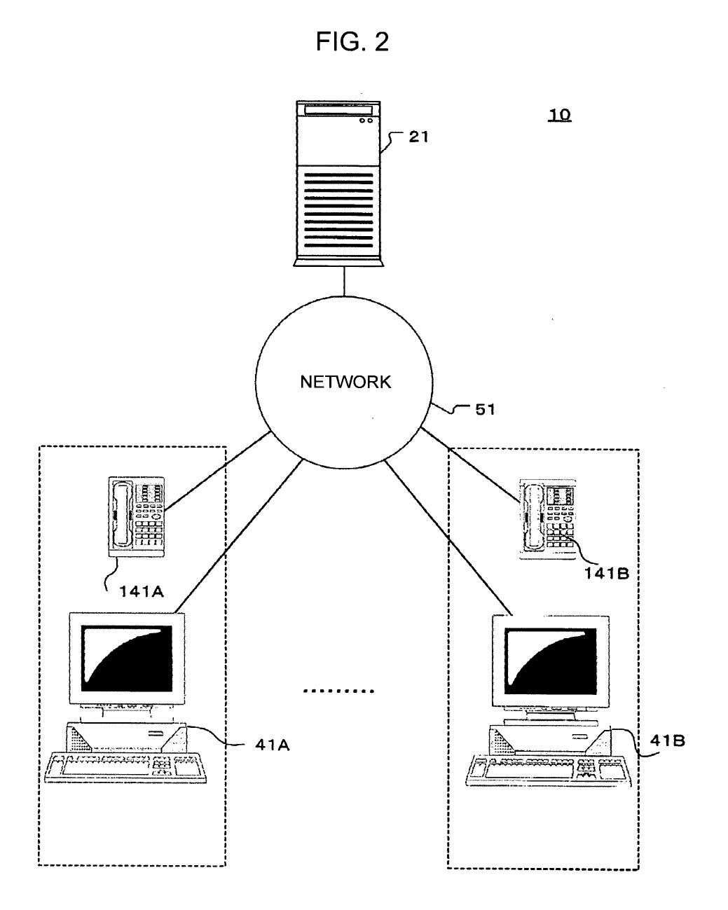

FIG. 3 is a block diagram of the assessment feedback system according to the embodiment of the present invention.

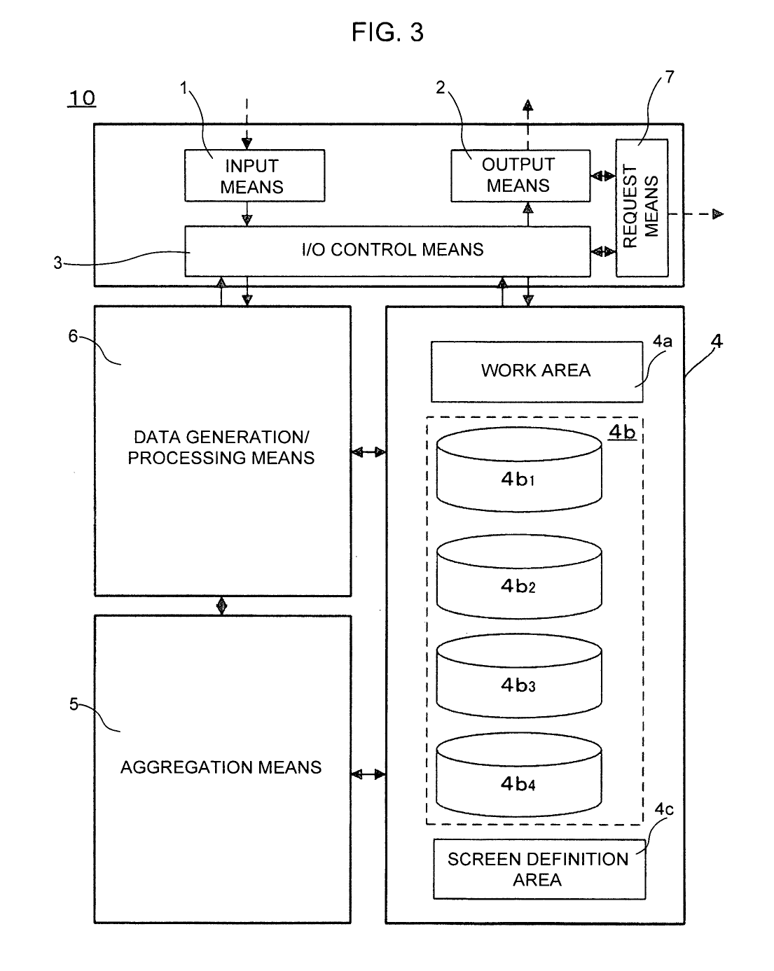

FIG. 4 shows an example of main assessment questionnaire data.

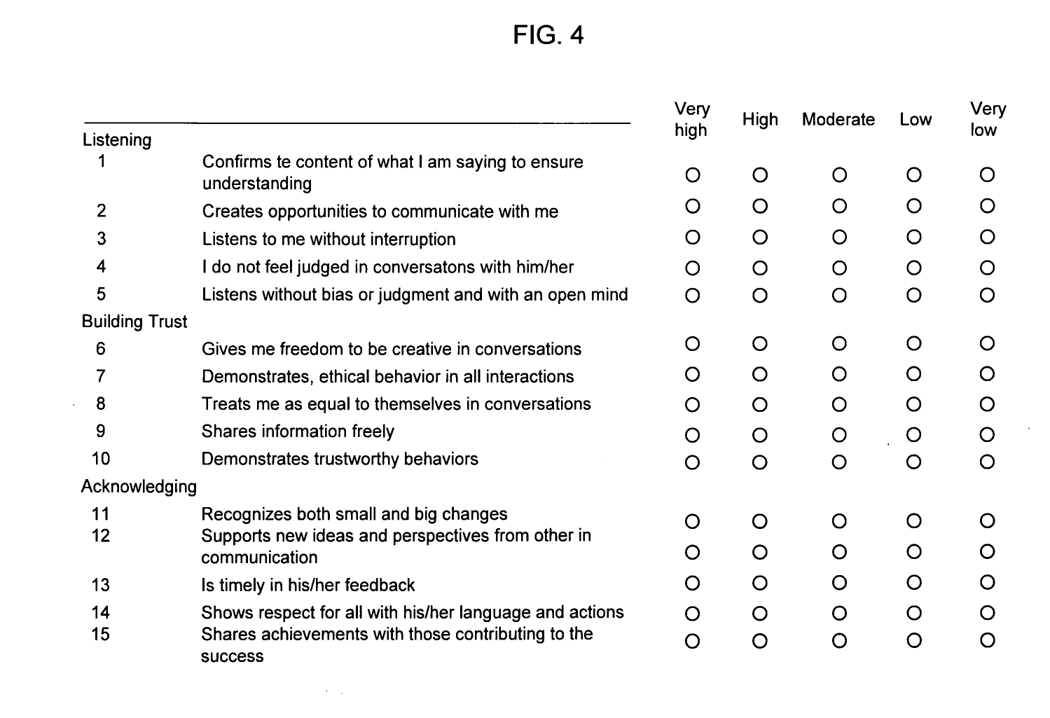

FIG. 5 shows an example of creating the main assessment questionnaire data.

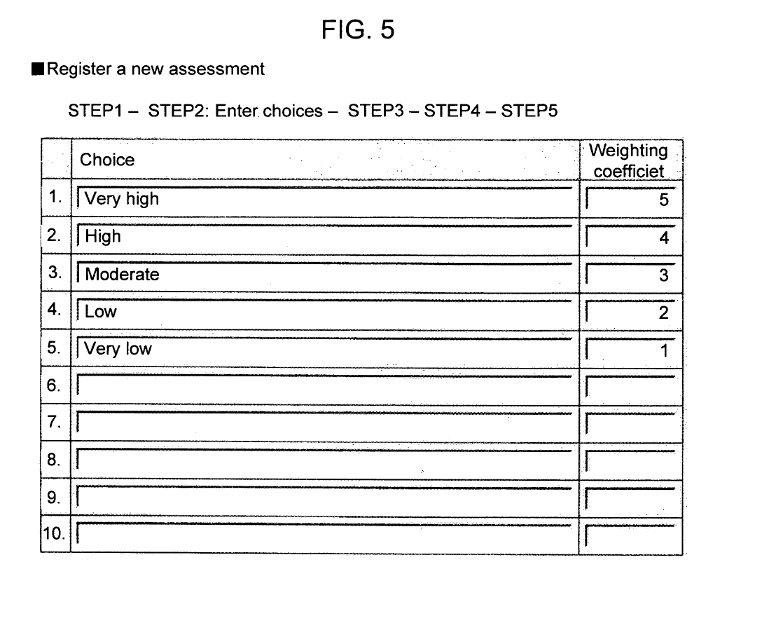

FIG. 6 shows the example of creating the main assessment questionnaire data.

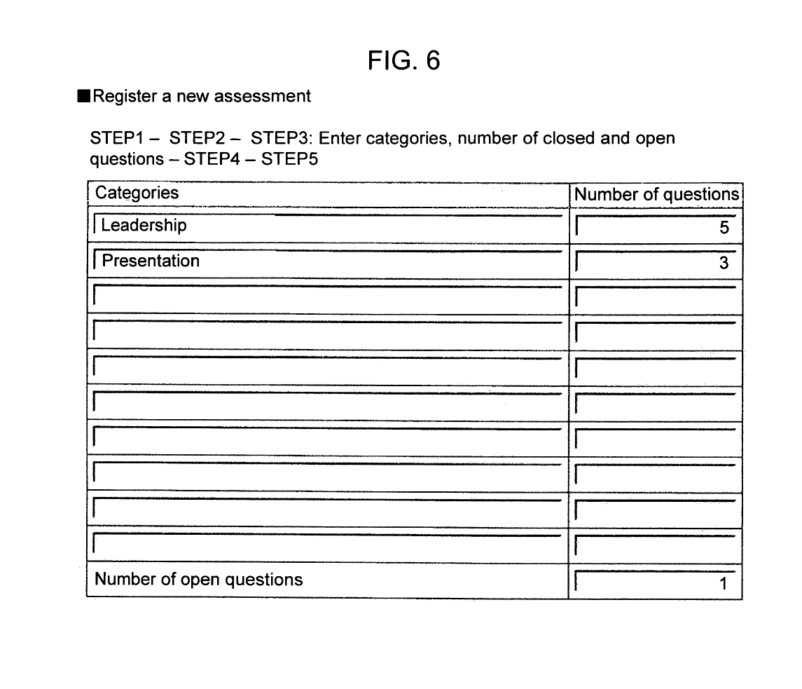

FIG. 7 shows the example of creating the main assessment questionnaire data.

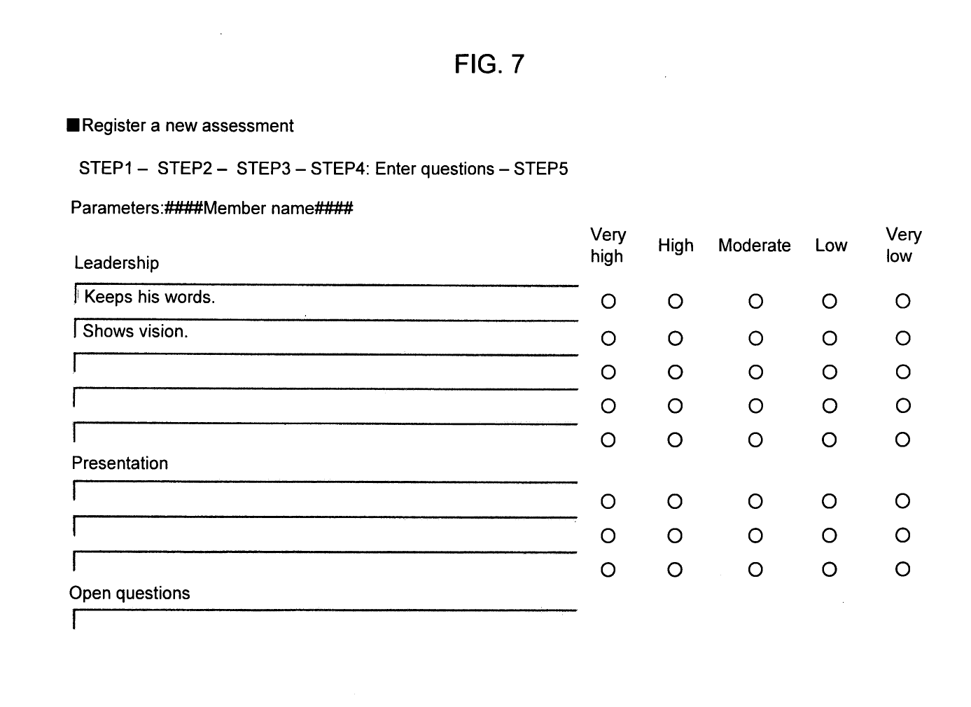

FIG. 8 shows an example of subsidiary assessment questionnaire data.

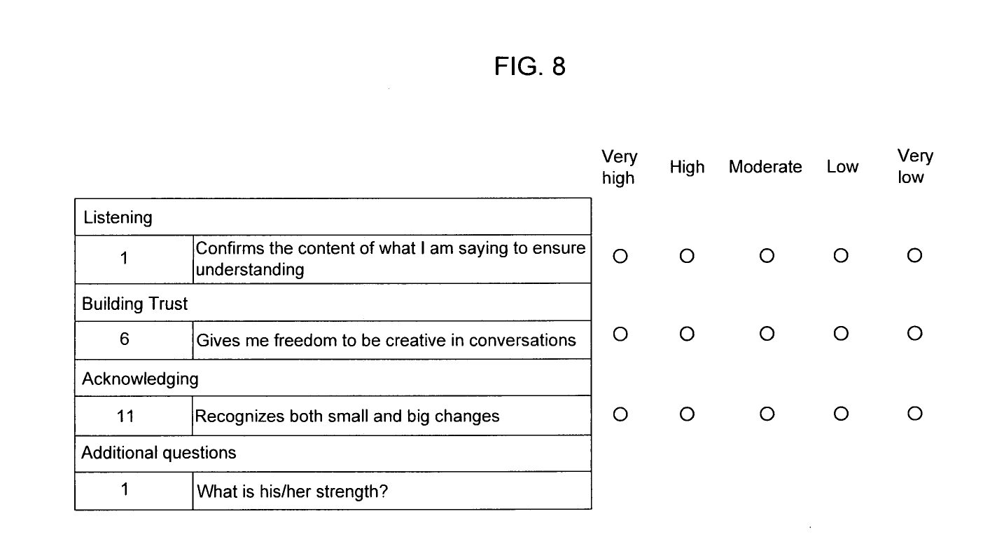

FIG. 9 shows an example of creating the subsidiary assessment questionnaire data.

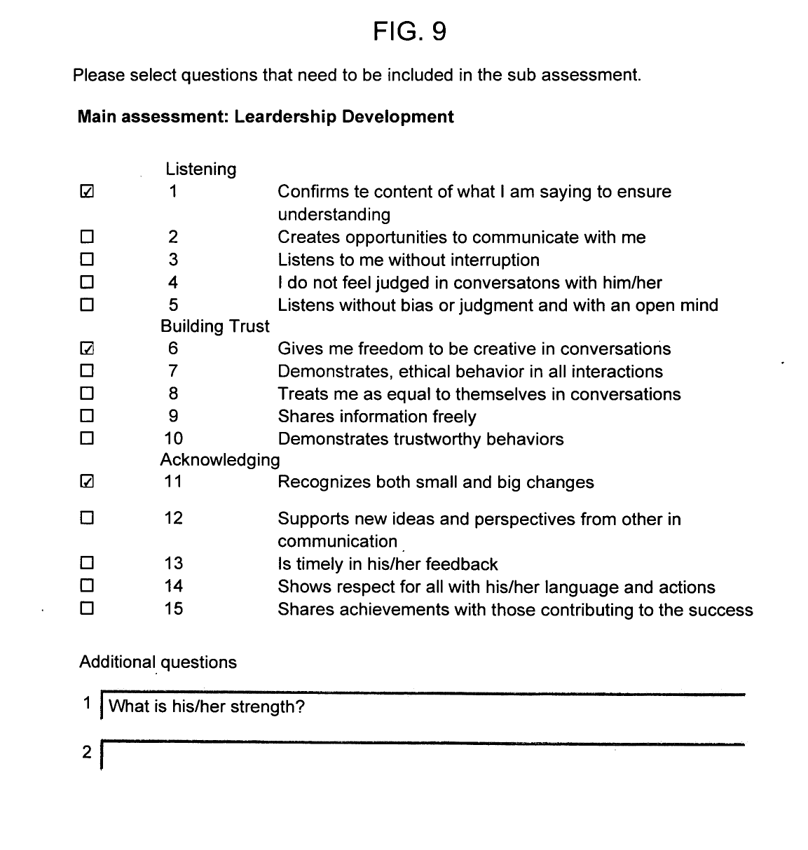

FIG. 10 shows the example of creating the subsidiary assessment questionnaire data.

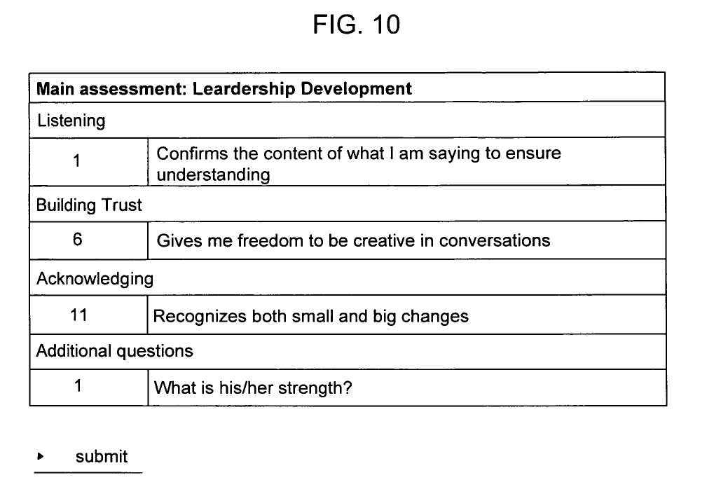

FIG. 11 shows an example of main assessment result data.

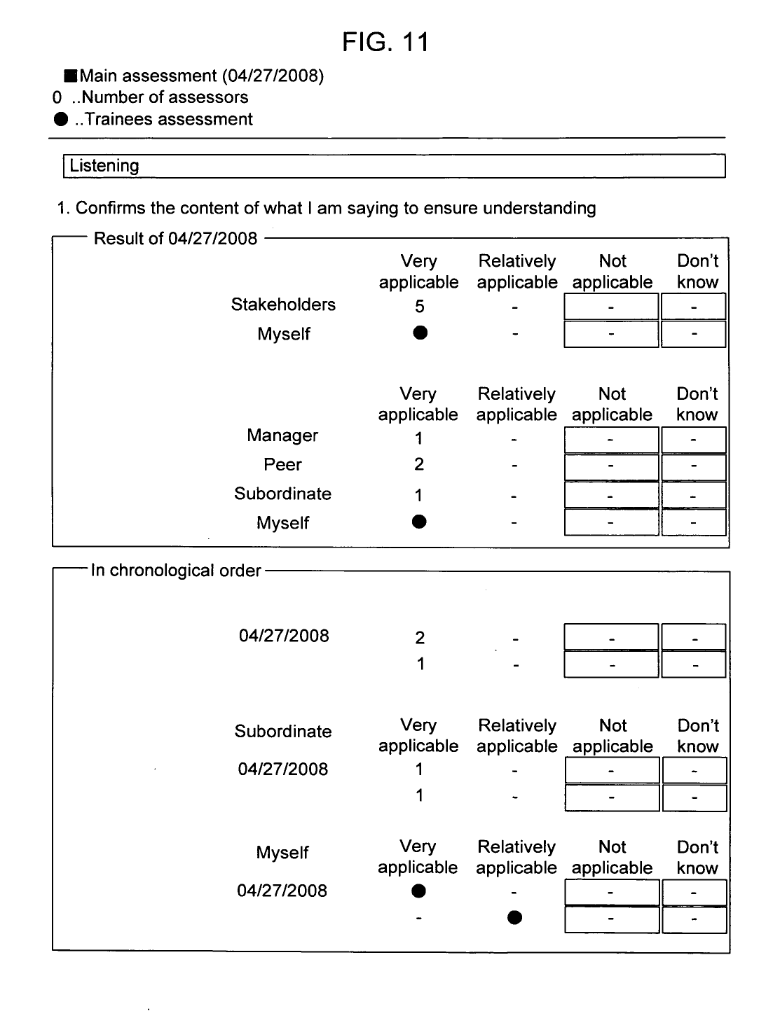

FIG. 12 shows a flow of data in the assessment feedback system according to the embodiment of the present invention.

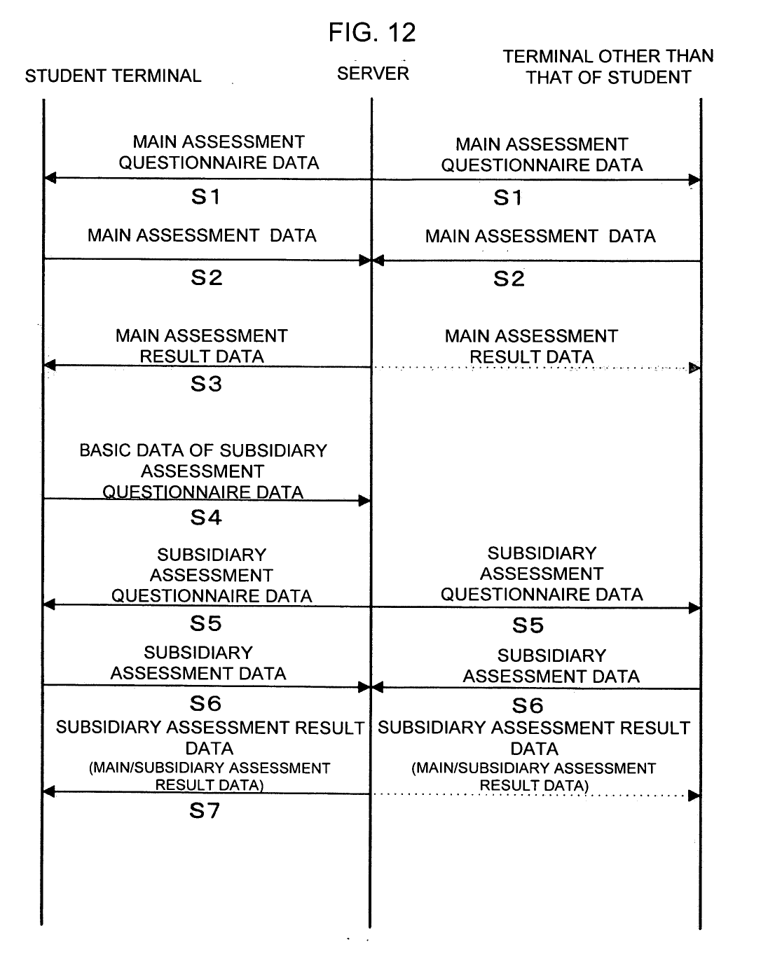

### DESCRIPTION OF REFERENCE NUMERALS

1 Input Means
2 Output Means
3 I/O Control Means
4 Storage Means
5 Aggregation Means
6 Data Generation/Processing Means
7 Request Means

1-3. (canceled)

4. A method of providing feedback to an assessed person, the method comprising the steps of:
transmitting main assessment questionnaire data to a student terminal operated by the assessed person and at least one other terminal different from the student terminal which is operated by an assessor, wherein the assessment questionnaire data comprises:
a plurality of assessment items divided into a plurality of categories, and
assessment factors provided separately for each of the plurality of assessment items,
receiving one assessment factor selected for each of the plurality of assessment items from the student terminal and the at least one other terminal as main assessment data;
aggregating the main assessment data received from the student terminal and the at least one other terminal for each of the plurality of assessment items;
generating a first aggregated data as main assessment result data based on results obtained from the aggregating step;
transmitting the main assessment result data to the student terminal;
requesting the student terminal to select one assessment item among the plurality of assessment items for each of the plurality of categories; and
generating subsidiary assessment questionnaire data according to information received from the student terminal after the requesting step.

5. The method of providing feedback to the assessed person as recited in claim 4, wherein the information received from the student terminal after the requesting step comprises one assessment item for each of the plurality of categories where the one assessment item is selected from the plurality of assessment items.

6. The method of providing feedback to the assessed person as recited in claim 5, wherein the subsidiary assessment questionnaire data comprises a plurality of one assessment items and assessments factors provided separately for each of the plurality of one assessment items.

7. The method of providing feedback to the assessed person as recited in claim 4, wherein an authentication process is used for allowing the student terminal and the at least one other terminal to access data.

8. The method of providing feedback to the assessed person as recited in claim 4, wherein the assessor comprises a manager, a peer, or a subordinate.

9. The method of providing feedback to the assessed person as recited in claim 4 further comprising the steps of:
requesting the student terminal and the at least one other terminal to select one assessment factor for each of the plurality of one assessment items using the subsidiary assessment questionnaire data;
receiving one assessment factor selected for each of the plurality of one assessment items from the student terminal and the at least one other terminal as subsidiary assessment data;
aggregating the subsidiary assessment data received from the student terminal and the at least one other terminal for each of the plurality of one assessment items;
generating a second aggregated data as subsidiary assessment result data based on results obtained from the aggregating step; and
transmitting the subsidiary assessment result data to the student terminal.

10. The method of providing feedback to the assessed person as recited in claim 9, wherein the subsidiary assessment questionnaire data is used a predetermined number of times to generate intermediate assessment results during a time period where training sessions are held.

11. The method of providing feedback to the assessed person as recited in claim 10, wherein the predetermined number of times comprises 2 or 3 times.

12. The method of providing feedback to the assessed person as recited in claim 10, wherein the time period where training sessions are held comprises 3 or 4 months.

13. The method of providing feedback to the assessed person as recited in claim 9 further comprising the steps of:
aggregating the main assessment data and the subsidiary assessment data for each of the plurality of assessment items;
generating a third aggregated data as main-subsidiary assessment result data; and
transmitting the main-subsidiary assessment result data to the student terminal.

14. An assessment system configured to provide feedback to an assessed person, the assessment system comprising:
at least two external terminals for performing assessments of the assessed person, wherein one external terminal is operated by the assessed person and the other external terminal is operated by an assessor;
a server configured to:
send main assessment questionnaire data to each of the at least two external terminals,
receive main assessment data from each of the at least two external terminals,
aggregate the main assessment data received from each of the at least two external terminals,
generate main assessment result data,
send a request to the assessed person to select one assessment item from a plurality of assessment items divided into a plurality of categories, and
generate subsidiary assessment questionnaire data according to information received from the assessed person; and
a network entity coupled to the server and the at least two external terminals.

15. The assessment system configured to provide feedback to the assessed person as recited in claim 14, wherein the server comprises:
an output interface for transmitting data or instructions to the at least two external terminals,
an input interface for receiving data or instructions from the external terminals,
a data transfer request interface for sending a request to the assessed person or the assessor,
an aggregation function for performing data processing to aggregate data received from the at least two external terminals, and
a data generation function for generating various type of data.

16. The assessment system configured to provide feedback to the assessed person as recited in claim 14, wherein the information received from the assessed person after sending the request comprises one assessment item for each of the plurality of categories where the one assessment item is selected from the plurality of assessment items.

17. The assessment system configured to provide feedback to the assessed person as recited in claim 14, wherein the assessor comprises a manager, a peer, or a subordinate.

18. The assessment system configured to provide feedback to the assessed person as recited in claim 14, wherein the network entity comprises the Internet.

19. The assessment system configured to provide feedback to the assessed person as recited in claim 14, wherein the at least two external terminals are allowed to access various data after performing an authentication process.

20. The assessment system configured to provide feedback to the assessed person as recited in claim 14, wherein the server is further configured to:
send a request to the at least two external terminals to select one assessment factor for each of the plurality of one assessment items using the subsidiary assessment questionnaire data;
receive subsidiary assessment data from each of the at least two external terminals;
aggregate the subsidiary assessment data received from each of the at least two external terminals;
generate subsidiary assessment result data; and
transmit the subsidiary assessment result data to the student terminal.

21. The assessment system configured to provide feedback to the assessed person as recited in claim 20, wherein the server is further configured to:
aggregate the main assessment data and the subsidiary assessment data for each of the plurality of assessment items;
generate main-subsidiary assessment result data; and
transmit the main-subsidiary assessment result data to the student terminal.

22. The assessment system configured to provide feedback to the assessed person as recited in claim 20, wherein the subsidiary assessment questionnaire data is used a predetermined number of times to generate intermediate assessment results during a time period where training sessions are held.

23. The assessment system configured to provide feedback to the assessed person as recited in claim 22, wherein the predetermined number of times comprises 2 or 3 times and the time period where training sessions are held comprises 3 or 4 months.
